(19) United States
(12) Patent Application Publication
(10) Pub. No.: US 2022/0147897 A1
(43) Pub. Date: May 12, 2022

(54) MACHINE LEARNING FOR PREDICTIVE OPTMIZATION

(71) Applicant: SparkCognition, Inc., Austin, TX (US)

(72) Inventors: Elad Liebman, Austin, TX (US); Jeremy Ritter, Austin, TX (US)

(21) Appl. No.: 17/453,987

(22) Filed: Nov. 8, 2021

Related U.S. Application Data
(60) Provisional application No. 63/112,769, filed on Nov. 12, 2020.

(51) Int. Cl. G06Q 10/06; G06Q 50/30

(52) U.S. Cl. CPC G06Q 10/06375; G06Q 50/30; G06Q 10/06314; G06Q 10/06393

(57) ABSTRACT

A method includes obtaining historical data including sensor data from one or more sensors associated with a device and contextual data indicative of one or more conditions external to the device and independent of operation of the device. The method also includes providing at least a portion of the historical data as input to one or more machine-learning-based projection models to generate projection data associated with a future condition of the device. The method further includes providing input data to one or more machine-learning-based optimization models to determine one or more operational parameters that are expected to improve an operational metric associated with one or more devices. The one or more devices include the device, and the input data is based, at least in part, on the historical data and the projection data.

### CROSS-REFERENCE TO RELATED APPLICATIONS

The present application claims priority to and is a continuation of U.S. Patent Application No. 63/112,769 entitled “MACHINE LEARNING FOR PREDICTIVE OPTMIZATION,” filed Nov. 12, 2020, the contents of which are incorporated herein by reference in their entirety.

### BACKGROUND

Traditionally, optimization is performed by plugging values into an equation that describes a system being optimized. It can be difficult to optimize complex systems where it is unclear what equation or equations describe relevant aspects of the system and which available data is important to the optimization calculation. Optimization is also challenging in circumstances in which there are a number of hidden or latent variables that describe the system. Complexity of the system also increases the difficulty of optimizing the system, even if all of the relevant variables and relationships have been identified.

### SUMMARY

A particular aspect of the disclosure describes a method that includes obtaining, at one or more processors of a computing device, historical data including sensor data from one or more sensors associated with a device and contextual data indicative of one or more conditions external to the device and independent of operation of the device. The method also includes providing, by the one or more processors, at least a portion of the historical data as input to one or more machine-learning-based projection models to generate projection data associated with a future condition of the device. The method further includes providing, by the one or more processors, input data to one or more machine-learning-based optimization models to determine one or more operational parameters that are expected to improve an operational metric associated with one or more devices. The one or more devices include the device, and the input data is based, at least in part, on the historical data and the projection data.

Another particular aspect of the disclosure describes a system that includes one or more memory devices storing historical data including sensor data from one or more sensors associated with a device and contextual data indicative of one or more conditions external to the device and independent of operation of the device. The system also includes one or more processors configured to provide at least a portion of the historical data as input to one or more machine-learning-based projection models to generate projection data associated with a future condition of the device. The one or more processors are further configured to provide input data to one or more machine-learning-based optimization models to determine one or more operational parameters that are expected to improve an operational metric associated with one or more devices. The one or more devices include the device, and the input data is based, at least in part, on the historical data and the projection data.

Another particular aspect of the disclosure describes a non-transitory computer-readable medium storing instructions that are executable by one or more processors to cause the one or more processors to perform operations. The operations include obtaining historical data including sensor data from one or more sensors associated with a device and contextual data indicative of one or more conditions external to the device and independent of operation of the device. The operations also include providing at least a portion of the historical data as input to one or more machine-learning-based projection models to generate projection data associated with a future condition of the device. The operations further include providing input data to one or more machine-learning-based optimization models to determine one or more operational parameters that are expected to improve an operational metric associated with one or more devices. The one or more devices include the device, and the input data is based, at least in part, on the historical data and the projection data.

The features, functions, and advantages described herein can be achieved independently in various implementations or may be combined in yet other implementations, further details of which can be found with reference to the following description and drawings.

### BRIEF DESCRIPTION OF THE DRAWINGS

FIG. 1 is a block diagram of an example of a system configured to determine, based on projection data, one or more operational parameters to improve operation of a device.

FIG. 2 is a block diagram of another example of the system of FIG. 1.

FIG. 3 is a block diagram of another example of the system of FIG. 1.

FIG. 4 is a diagram illustrating an example of operations performed by the system of FIG. 2.

FIG. 5 is a flow chart of an example of a method that may be performed by the system of any of FIGS. 1-3.

FIG. 6 is a diagram illustrating details of a first example of a process to generate one or more machine-learning models of the system of FIG. 1.

FIG. 7 is a diagram illustrating details of a second example of a process to generate one or more machine-learning models of the system of FIG. 1.

FIG. 8 is a diagram illustrating details of a third example of a process to generate one or more machine-learning models of the system of FIG. 1.

### DETAILED DESCRIPTION

Particular aspects of the present disclosure are described below with reference to the drawings. In the description, common features are designated by common reference numbers throughout the drawings. As used herein, various terminology is used for the purpose of describing particular implementations only and is not intended to be limiting. For example, the singular forms “a,” “an,” and “the” are intended to include the plural forms as well, unless the context clearly indicates otherwise. It may be further understood that the terms “comprise,” “comprises,” and “comprising” may be used interchangeably with “include,” “includes,” or “including.” Additionally, it will be understood that the term “wherein” may be used interchangeably with “where.” As used herein, “exemplary” may indicate an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

In the present disclosure, terms such as “determining,” “calculating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “using,” “selecting,” “accessing,” and “determining” may be used interchangeably. For example, “generating,” “calculating,” or “determining” a parameter (or a signal) may refer to actively generating, calculating, or determining the parameter (or the signal) or may refer to using, selecting, or accessing the parameter (or signal) that is already generated, such as by another component or device.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc. As used herein, “directly coupled” may include two devices that are coupled (e.g., communicatively coupled, electrically coupled, or physically coupled) without intervening components.

Particular aspects of the disclosure relate to using machine learning to perform predictive optimization (e.g., optimization of predicted values or states). In this context, to “predict” refers to projecting future conditions (e.g., states or values) based on modeling. Predicting in this sense is distinct from estimating current conditions that are hidden or not measurable. Thus, as used herein “estimating” and its variants refers to determining, calculating, or otherwise assigning a value to a current or past condition, and “predicting” and its variants refers exclusively to determining, calculating, or otherwise assigning a value to a future condition. Additionally, in this context “optimization” refers to improving an operational condition or variable as measured by some objective function. Optimization does not require identifying an optimum value (i.e., a best possible value of the objective function under constraints). Rather, optimization, as used herein, is the process of seeking improvement of the objective function.

In some circumstances, operation of a system can be improved by modifying current operation of the system based on a predicted future state or value. To illustrate, predictively caching data can improve the operation of a computer system (e.g., by decreasing cache misses) even though the predictions are sometimes wrong. An aspect of the present disclosure seeks to apply prediction to more complex optimization tasks of various types.

For simple, well-characterized, and quantifiable systems, relatively straightforward equations can be solved to identify changes that improve operation of the system (or even to identify true optimum conditions (e.g., global minimum values of the objective function). However, such systems are generally idealized rather than real-world system. In many real-world situations, it is difficult to mathematically model the system and all of the relevant variable. Such systems are sometimes referred to as complex systems, where “complex” is used to indicate that a system includes many components that interact with one another in ways that are difficult to mathematically model or are hidden. As a result, it can be difficult or impossible to fully mathematically model a complex system using a set of equations, and there may be no mathematical model available that accurately describes the complex system. To illustrated, the complex system may have hidden dependencies (e.g., latent variables) that are difficult to quantify, difficult to model mathematically, unrecognized, or a combination thereof. Further, in some circumstances, even if a mathematically model is available to describe the complex system, optimization of the mathematical model may, in terms of computing resources used (e.g., processor time, memory, and power), be computationally intractable or extremely inefficient.

Various machine-learning techniques are disclosed herein to enable predictive optimization of complex systems. For example, machine-learning models are trained to predict particular values based on historical values. In this example, the machine-learning models are able to account for hidden dependencies and can be specifically configured to be computationally efficient (e.g., model complexity can be used as a training or selection criterion). In some aspects, using machine-learning models mitigates or eliminates the need to generate a mathematically model to accurately describe the complex system. In some aspects, machine-learning models and mathematical models (such as physics-based models) are used together to perform prediction or optimization operations. For example, mathematical models may be used where such are available and useful, and output of such mathematical models can be provided as input to machine-learning models to more fully model the complex system or to account for aspects of the complex system that are not fully captured by the mathematical models. Conversely, one or more machine-learning models can be used to determine (e.g., predict or estimate) a value of a dependent variable of a mathematical model. In addition to allowing reduced computational complexity and description of complex systems that are difficult to mathematically model, machine-learning models can be periodically, occasionally, or continuously updated to improve performance or to account for variations within the complex system.

In aspects described herein, one or more projection models and one or more optimization models are trained based on historical data. The projection model(s) are machine-learning models that take as input real-time data, historical data, or a combination thereof, and generate as output projection data indicating one or more predicted future values or predicted future states associated with an optimization target (e.g., a complex system that is being optimized to improve one or more operational metrics). The optimization model(s) are machine-learning models that take as input the projection data (and perhaps also certain real-time data, historical data, or both) and generate as output data descriptive of one or more operational parameters that are expected to improve the operational metric(s).

In a particular aspect, optimization as described herein can be applied to various devices or sets of devices. To illustrate, operation of a single device, such as a vehicle, can be optimized based on sensor data as well as contextual data that is indicative of one or more conditions external to the device and independent of operation of the device. As another example, operation of a set of devices (e.g., a fleet of vehicles) can be optimized by aggregating data for multiple vehicles and contextual data.

As one specific example, historical data can be used to generate a predictive model to simulate the results of an action, such as converting a vehicle from diesel to electric. The predictive model, or a set of predictive models, can simulate multiple results of such actions, such as resulting performance, resulting vehicle life, resulting energy efficiency, etc. The predictive model(s) can be used to decide a future action, such as to change route of a vehicle or convert the vehicle from diesel to electric. After such decisions are made, new data can be gathered and used to update the predictive model(s).

In a particular aspect, supervised learning, semi-supervised learning, unsupervised learning, reinforcement learning, or other techniques may be used in conjunction with the present disclosure. For example, supervised or semi-supervised learning may be used when there is at least an idea of labels and/or categories of training data available. On the other hand, unsupervised learning may be applicable when there is little to no available information regarding labels or categories, such as in the case of clustering or anomaly detection. Non-limiting examples of decisions that are well-suited for reinforcement learning techniques include: choosing which vehicle(s) of a fleet to convert to hybrid or electric operation, when to perform such conversions, fleet task allocation and scheduling, route optimization, vehicle/fleet maintenance scheduling, vehicle control (e.g., airflow/fuel flow, valve opening/closing, gear management, speed/RPM). Depending on the quality and nature of the data available, one or more machine learning techniques may be used to estimate hidden or latent variables that are not captured in the data available, to forecast future observations based on present data, to estimate the expected outcomes of various decisions, or combinations thereof.

Reinforcement learning is a machine-learning paradigm that is particular well suited for training models for sequential decision-making. A simple example of sequential decision-making includes operations performed to decide when to turn on and off a thermostat to maintain temperature within certain parameters. More complex examples of sequential decision-making may include path-planning and navigation by an autonomous vehicle in response to environmental cues, such as traffic lights and other vehicles. Problems which involve sequential decision-making can be framed as Markov Decision Processes (MDPs). Inferring an optimal control policy from known MDP dynamics is referred to as solving the MDP. However, if an MDP is very large, or if it is largely unknown, solving it may be infeasible. Reinforcement learning techniques are able to simultaneously learn the properties of the MDP (either explicitly, which is referred to as “model based learning”, or implicitly, which is referred to as “model free learning”) and learn an optimal behavior policy. Illustrative, non-limiting examples of reinforcement learning algorithms include Q-learning and temporal difference learning (e.g., TD-lambda learning), proximal policy optimization (PPO), deep deterministic policy gradients (DDPG), and soft actor-critic (SAC).

Other machine-learning processes may also be used to do one or more of the following: generate projection models, to generate optimization models, to generate supporting models, or to train or improve such models. In the context of time series data, examples of such machine-learning processes include, without limitation, auto regressive integrated moving average (ARIMA), vector autoregression moving average with exogenous regressors (VARMAX), Temporal Convolutional Networks (TCNs), time series autoencoders, or variants or ensembles thereof.

In some aspects, attention layers may be used to facilitate identifying which data sources are more relevant in different contexts for the purpose of modeling/decision making. In some aspects, representation learning may be used to facilitate reconciling many possibly contradictory data sources into one cohesive input space. Additionally, clustering and/or metric learning to autoencoders may be used for similar reasons

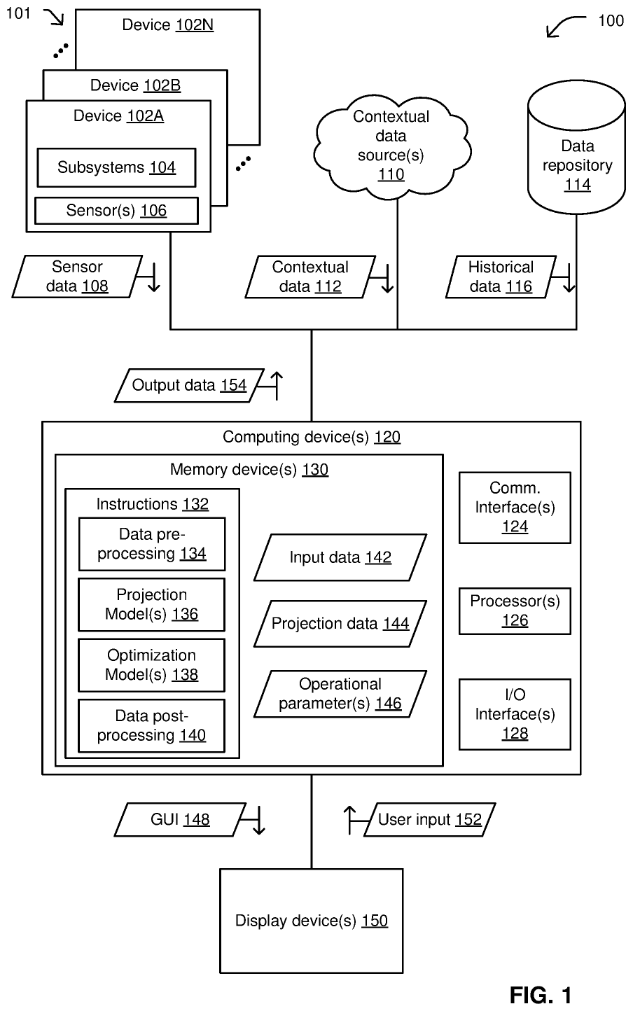

FIG. 1 is a block diagram of an example of a system 100 configured to determine, based on projection data, one or more operational parameters to improve operation of one or more device 102. FIG. 1 illustrates a group 101 of devices, including a first device 102A, a second device 102B, and an Nth device 102N, where N is any positive integer greater than two. Although FIG. 1 illustrates three devices 102 in the group 101, the operations described below can be performed with respect to a single device, such as the first device 102A, or any other subset of the group 101. In some implementations, the group 101 is a set of device(s) 102 that is associated with (e.g., owned, operated, manufactured, or controlled) by a single entity, such as a government, a company, or a private entity.

The system 100 includes one or more computing devices 120 that are configured to receive data from various sources, to project one or more future values, and to determine one or more operational parameters 146 associated with the device(s) 102 to improve one or more operational metrics associated with the device(s) 102. The computing device(s) 120 uses one or more machine-learning models to generate projection data 144 indicating the one or more future values and to perform optimization operations to determine the operational parameter(s) 146. One benefit of using machine-learning models for data projection and optimization is that machine-learning models are able to account for non-linear or unspecified relationships among complex and varying data sets while using fewer computing resources than would be needed to enumerate and specifically define the relationships heuristically.

Each of the one or more computing device(s) 120 includes one or more processors 126, one or more communication interface devices 124, one or more input/output (I/O) interface devices 128, and one or more memory devices 130. In some examples, the computing device(s) 120 include one or more host computers, one or more servers, one or more workstations, one or more desktop computers, one or more laptop computers, one or more Internet of Things devices (e.g., a device with an embedded processing systems), one or more other computing devices, or combinations thereof.

The processor(s) 126 include one or more single-core or multi-core processing units, one or more digital signal processors (DSPs), one or more graphics processing units (GPUs), or any combination thereof. The processor(s) 126 are configured to access data and instructions 132 from the memory device(s) 130 and to perform various operations described further below. The processor(s) 126 are also coupled to the communication interface device(s) 124 to receive data from another device (such as a data repository 114, one or more contextual data sources 110, the device(s) 102, etc.), to send data to another device, or both. The processor(s) 126 are also coupled to the I/O interface device(s) 128 to output data in a manner that is perceivable by a user, to receive input from the user, or both.

The communication interface device(s) 124 and I/O interface device(s) 128 include one or more serial interfaces (e.g., universal serial bus (USB) interfaces or Ethernet interfaces), one or more parallel interfaces, one or more video or display adapters, one or more audio adapters, one or more other interfaces, or a combination thereof. Additionally, the communication interface device(s) 124 and I/O interface device(s) 128 include wired interfaces (e.g., Ethernet interfaces), wireless interfaces, or both.

The memory device(s) 130 include tangible (i.e., non-transitory) computer-readable media, such as a magnetic or optical memory or a magnetic or optical disk/disc. For example, the memory device(s) 130 include volatile memory (e.g., volatile random access memory (RAM) devices), nonvolatile memory (e.g., read-only memory (ROM) devices, programmable read-only memory, or flash memory), one or more other memory devices, or a combination thereof.

The instructions 132 are executable by the processor(s) 126 to cause the processor(s) 126 to perform operations to determine projection data 144 and to determine one or more operational parameters 146 based on projection data 144. The operational parameter(s) 146 are selected to improve one or more operational metrics associated with the device(s) 102. In the example illustrated in FIG. 1, the instructions 132 include one or more machine-learning models, such as one or more projection models 136 and one or more optimization models 138. In other examples, the instructions 132 include additional machine-learning models. To illustrate, in FIG. 1, the instructions 132 include data pre-processing instructions 134 and data post-processing instructions 140. In some implementations, the data pre-processing instructions 134, the data post-processing instructions 140, or both, include one or more machine-learning models.

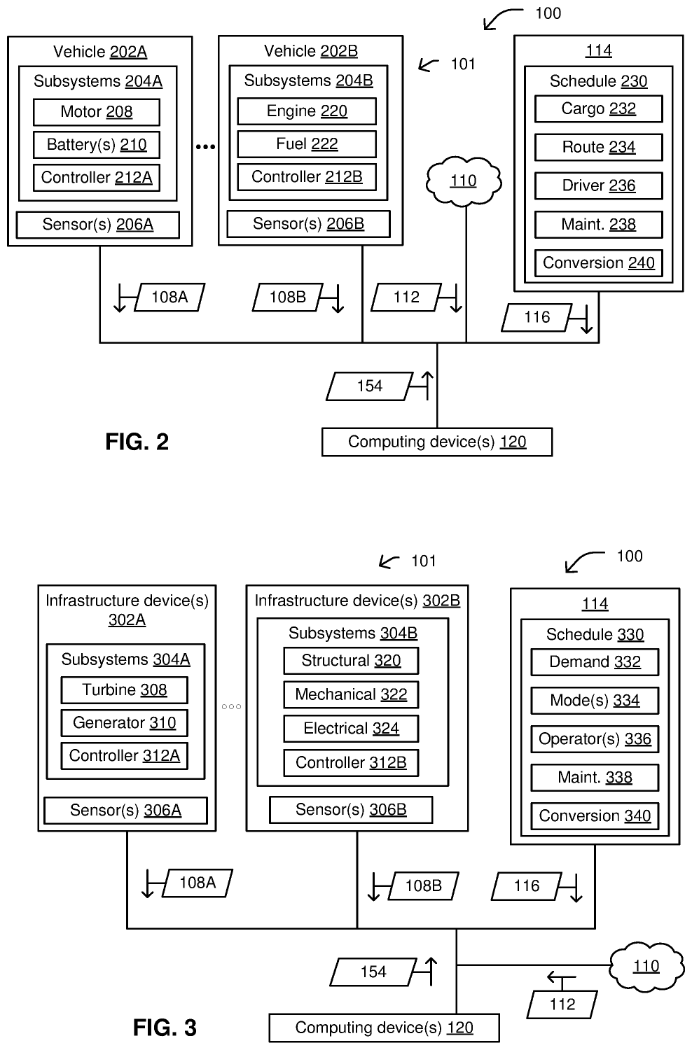

The device(s) 102 can include, correspond to, or be included within a variety of different devices depending on the specific implementation. For example, in some implementations, the device(s) 102 include, correspond to, or are included within vehicles, such as ships, cars, buses, trucks, trains, aircraft, etc., any of which may be autonomous (also referred to as “unmanned” or “drones”), human-operated by an onboard operator (also referred to as “manned”), remotely operated by a human, or semi-autonomous. As another example, in some implementations, the device(s) 102 include, correspond to, or are included within industrial equipment, infrastructure devices, etc. Specific examples of the devices 102 are described with reference to FIGS. 2 and 3

In FIG. 1, each device 102 of the group 101 includes a plurality of subsystems 104 and one or more sensors 106. The subsystems 104 include mechanical subsystems, electrical subsystems, computing subsystems, communication subsystems, energy storage and/or generation subsystems, control subsystems, or combinations of these or other illustrative subsystems. To illustrate, the subsystems 104 may include generators, engines, motors, turbines, structural members, cargo containers, batteries, brakes, radios, lasers, etc. Specific examples of subsystems 104 corresponding to certain illustrative devices 102 are described with reference to FIGS. 2 and 3.

The sensor(s) 106 are configured to generate sensor data 108 associated with the device(s) 102. For example, the sensor(s) 106 generate sensor data 108 to indicate detected conditions associated with the device 102A, one or more of the subsystems 104, or both. The sensor data 108 can include raw data (e.g., acceleration as determined by an accelerometer), calculated or inferred data (e.g., acceleration as determined based on speed readings over time), or both. The content of the sensor data 108 varies from one implementation to another depending on the nature of the device(s) 102, the nature of the subsystems 104, and the types of sensor(s) 106 used. Examples of the sensor data 108 include data indicating a state of charge of at least one cell of a battery of the device(s) 102, an electric current load associated with the device(s) 102, a cell voltage of at least one cell of the battery, a cell temperature of at least one cell of the battery, a fluid pressure of a fluid of the device(s) 102, a speed of the device(s) 102, an acceleration of the device(s) 102, a braking metric associated with the device(s) 102, a weight of the device(s) 102, a weight of cargo of the device(s) 102, a center of gravity of the device(s) 102, a cargo identifier, a cargo type of the device(s) 102, a rotation rate associated with the device(s) 102, an alert associated with the device(s) 102, a fluid flow rate associated with the device(s) 102, a torque output of a component of the device(s) 102, a chemical reaction metric associated with the device(s) 102, a frequency of a waveform associated with the device(s) 102, an amplitude of the waveform, an encoding scheme of the waveform, an indication of a type of the waveform, a power-level of the waveform, etc. Examples of waveforms that may be indicated by the sensor data 108 include acoustic waveforms and electromagnetic waveforms, either of which may be useful (e.g., for diagnostics).

In addition to the sensor data 108, the computing device(s) 120 are configured to obtain contextual data 112 from one or more contextual data sources 110. The contextual data source(s) 110 may include websites, server computers, sensors that are not onboard the device(s) 102, other data feeds that are external to the device(s) 102 and independent of the operation of the device(s) 102, or combinations thereof.

The contextual data 112 is indicative of one or more conditions external to the device(s) 102 and independent of operation of the device(s) 102. Examples of contextual data 112 include market data, such as pricing data or past, present, or future demand data (e.g., demand projections or historical demand information). Other examples of contextual data 112 include route topography, road quality, weather, a route type, availability of other device(s) 102 of the group 101, or combinations thereof.

The computing device(s) 120 are also configured to obtain historical data 116 from one or more data repositories 114. A data repository 114 may include a server computer, memory onboard the device(s) 102, memory of the computing device(s) 120 (e.g., the memory device(s) 130), other data storage devices, or combinations thereof. The historical data 116 indicates historical values of the sensor data 108, historical values of the contextual data 112, or both.

During operation, the processor(s) 126 of the computing device(s) 120 obtain the sensor data 108, the contextual data 112, the historical data 116, or some combination thereof, and provide at least a portion of the received data as input to the projection model(s) 136 to generate the projection data 144. For example, in some implementations, the processor(s) 126 provide at least a portion of the historical data 116 as input to the projection model(s) 136. In this example, the historical data 116 includes at least historical sensor data values and may also include historical contextual data values. The projection model(s) 136 are machine-learning-based models, such as one or more neural networks (e.g., temporal convolutional networks), one or more nonlinear regression models, one or more random forests, one or more reinforcement learning models, one or more autoencoders (e.g., time series autoencoders), or a combination thereof.

The projection data 144 generated by the projection model(s) 136 predicts a future condition of the device(s) 102. For example, the projection data 144 may indicate a future configuration requirement associated with the device(s) 102, a future demand associated with the device(s) 102, a future sensor data value associated with the sensor(s) 106, a cost prediction associated with the device(s) 102 (such as a fuel cost or maintenance cost), or a combination thereof. In some implementations, the projection model(s) 136 also generate contextual projection data indicative of a forecasted value of the one or more conditions external to the device(s) 102 that are indicted by the contextual data 112. In such implementations, the projection data 144 includes the contextual projection data.

The processor(s) 126 are further configured to generate input data 142 based on the projection data 144. For example, the processor(s) 126 may execute the data pre-processing instructions 134 to generate the input data 142. In some implementations, the input data 142 may also be based, in part, on the sensor data 108, the contextual data 112, the historical data 116, or a portion or combination thereof. The input data 142 is provided as input to the optimization model(s) 138 to determine one or more operational parameters 146 that are expected to improve an operational metric associated with the device(s) 102. The optimization model(s) 138 are machine-learning-based models, such as neural networks, nonlinear regression models, random forests, reinforcement learning models, or a combination thereof.

The particular operational metric improved by the operational parameter(s) 146 varies from implementation to implementation. For example, the operational metric may be selected based on the nature of the device(s) 102, the number of device(s) 102 in the group 101, the goals of an operator or other entity associated with the device(s) 102, etc. As specific examples, the operational parameter(s) 146 may be selected to reduce costs, improve cycle times, improve uptime, improve efficiency, improve customer satisfaction, reduce environmental impact, etc.

In some implementations, the operational parameter(s) 146 assign operational schedule(s) to the device(s) 102 (e.g., by indicating start time, a stop time, a maintenance schedule, a charge time, a route, or a combination thereof). In some implementations, the operational parameter(s) 146 are associated with modification of a device 102. For example, the operational parameter(s) 146 may indicate timing for a full or partial conversion of a vehicle to electric or hybrid operation, modifications to be performed to at least partially convert the vehicle for electric or hybrid operation, or both. In some implementations, the operational parameter(s) 146 are associated with uses to which the device(s) 102 are assigned. To illustrate, the operational parameter(s) 146 may indicate a vehicle operational parameter, may assign the vehicle to a particular route, may specify an order of travel to a set of stop locations, may assign particular cargo to the vehicle, or may assign a particular device operator to the device (such as assigning a driver to a vehicle). In some implementations, the operational parameter(s) 146 includes one or more of a calibration setting of a subsystem 104 of the device 102, a maintenance schedule of the device 102, a control profile of the device 102, a fuel consumption parameter, a route assignment, a route schedule, or a combination thereof.

In some implementations, the input data 142, the projection data 144, or both, relate to more than one device 102 of the group 101. For example, the group 101 may include a fleet of vehicles (e.g., each device 102 may correspond to a vehicle of the fleet). In this example, the input data 142, the projection data 144, or both, may be associated with the fleet or with a subset of the fleet, such as each non-electric vehicle of the fleet or each electric vehicle of the fleet. In such implementations, the input data 142 may be based, at least in part, on the projection data 144 associated with more than one device 102 of the group 101, and the optimization model(s) 138 may determine groupwide operational parameters.

In a particular implementation, the data post-processing instructions 140 are executable by the processor(s) 126 to generate a graphical user interface (GUI) 148 to display information related to data input to or output by the projection model(s) 136, the optimization model(s) 138, or both. For example, the GUI 148 may include values, graphics, or controls based on the sensor data 108, the contextual data 112, the historical data 116, the input data 142, the projection data 144, the operational parameter(s) 146, or a combination thereof. In some implementations, the GUI 148 may be presented to a user via one or more display devices 150, and the user can proved user input 152 responsive to the GUI 148. For example, the GUI 148 can include a particular value of an operational parameter 146, and the user input 152 can indicate acceptance of the particular value or may include a modification of the particular value.

In some implementations, the data post-processing instructions 140 are executable by the processor(s) 126 to generate output data 154 based on the projection data 144, the operational parameter(s) 146, or both. In such implementations, the output data 154 are sent to the device(s) 102, to the data repository 114, or both. For example, the output data 154 may include a modification or update of a schedule, which may be stored at the data repository 114 for future reference or use (e.g., to automatically initiate an action based on the schedule). As another example, the output data 154 may include a command sent to a controller onboard a device 102 to cause the device 102 to modify operational characteristics of the device 102 based on the operational parameter(s) 146. To illustrate, the command may cause the controller to change a speed at which the device 102 operates.

FIG. 2 is a block diagram of another example of the system of FIG. 1. In the example, illustrated in FIG. 2, the group 101 includes a fleet of vehicles 202. Thus, in FIG. 2, each vehicle 202 represents, includes, or is included within one of the devices 102 of FIG. 1. FIG. 2 also illustrates the contextual data source(s) 110, the data repository 114, and the computing device 120 of FIG. 1, each of which operates as described with reference to FIG. 1. The example illustrated in FIG. 2 provides further details regarding operation of the system 100 in the context of managing a fleet of vehicles 202. The vehicles 202 may be autonomous, semi-autonomous, remotely operated, or manually controlled. Additionally, the vehicles 202 may include aircraft, land craft, watercraft, and/or spacecraft.

In the example of FIG. 2, one or more of the vehicles, such as a vehicle 202A is an electric or hybrid electric vehicle. For example, subsystems 204A of the vehicle 202A include one or more motors 208, one or more batteries 210, a controller 212A. The vehicle 202A also includes sensor(s) 206A configured to monitor the subsystems 204A. To illustrate, the sensor(s) 206A may be configured to generate sensor data 108A, such as a state of charge of at least one cell of a battery 210 of the vehicle 202A, an electric current load associated with the vehicle 202A, a cell voltage of at least one cell of the battery 210, a cell temperature of at least one cell of the battery 210, etc. The sensor data 108A may also include other data related to the vehicle 202A, such as a fluid pressure of a fluid of the vehicle 202A, a speed of the vehicle 202A, an acceleration of the vehicle 202A, a braking metric associated with the vehicle 202A, a weight of the vehicle 202A, a weight of cargo of the vehicle 202A, a center of gravity of the vehicle 202A, a cargo identifier, a cargo type of the vehicle 202A, a rotation rate associated with the vehicle 202A, an alert associated with the vehicle 202A, a fluid flow rate associated with the vehicle 202A, torque output of a component of the vehicle 202A, chemical reaction metric associated with the vehicle 202A, a frequency of a waveform associated with the vehicle 202A, an amplitude of the waveform, an encoding scheme of the waveform, an indication of a type of the waveform, a power-level of the waveform, etc.

The controller 212A is configured to control operation of the subsystems 204A onboard the vehicle 202A. For example, the controller 212A may control a rate of charging or discharging of the batteries 210, types or quantity of loads coupled to the batteries 210, whether the motor(s) 208 are used for regenerative braking, a speed or acceleration associated with the motor(s) 208, or other operational characteristic of the vehicle 202A. In some implementations, the controller 212A controls the subsystems 204A responsive to one or more commands or data of the output data 154 from the computing device(s) 120. For example, the output data 154 may include a command to cause the controller 212A to modify operational characteristics of the vehicle 202A based on the operational parameter(s) 146.

In the example of FIG. 2, one or more of the vehicles, such as a vehicle 202B is a gasoline, diesel, natural gas, or other non-electric vehicle. For example, subsystems 204B of the vehicle 202B include an engine 220 (e.g., an internal combustion engine), fuel 222, and a controller 212B.

The vehicle 202B also includes sensor(s) 206B configured to monitor the subsystems 204B. To illustrate, the sensor(s) 206B may be configured to generate sensor data 108B, such as a fluid level (such as a fuel level of the fuel 222), a fluid flow rate associated with the vehicle 202B (such as fuel flow rate of the fuel 222), a fluid temperature or pressure (such as an oil temperature or pressure in the engine 220), a chemical reaction metric (such as a fuel/air ratio of the engine 220), a torque output of the engine 220, a state of charge of at least one cell of a battery associated with the engine 220, an electric current load associated with the vehicle 202B, a cell voltage of at least one cell of the battery associated with the engine 220, a cell temperature of at least one cell of the battery associated with the engine 220, etc. The sensor data 108B may also include other data related to the vehicle 202B, such as a speed of the vehicle 202B, an acceleration of the vehicle 202B, a braking metric associated with the vehicle 202B, a weight of the vehicle 202B, a weight of cargo of the vehicle 202B, a center of gravity of the vehicle 202B, a cargo identifier, a cargo type of the vehicle 202B, a rotation rate associated with the vehicle 202B, an alert associated with the vehicle 202B, a frequency of a waveform associated with the vehicle 202B, an amplitude of the waveform, an encoding scheme of the waveform, an indication of a type of the waveform, a power-level of the waveform, etc.

The controller 212B is configured to control operation of the subsystems 204B onboard the vehicle 202B. For example, the controller 212B may control a fuel/air ratio provided to the engine 220, timing and rate of firing of cylinders of the engine 220, etc. In some implementations, the controller 212B controls the subsystems 204B responsive to one or more commands or data of the output data 154 from the computing device(s) 120. For example, the output data 154 may include a command to cause the controller 212B to modify operational characteristics of the vehicle 202B based on the operational parameter(s) 146.

In some implementations, the output data 154 based on the operational parameter(s) 146 is used to store or update a schedule 230 associated with the vehicles 202. For example, the schedule 230 may indicated cargo 232 that is assigned to one or more of the vehicles 202, and the output data 154 may update or modify the cargo 232 assigned to a particular vehicle 202 based on the operational parameter(s) 146. To illustrate, the contextual data 112 or the projection data 144 may include a demand projection and the particular cargo 232 is assigned to the vehicle 202A may be based in part on the demand projection.

As another example, the schedule 230 may indicated a route 234 (e.g., a delivery route) to which one or more of the vehicles 202 is assigned, and the output data 154 may update or modify the route 234 to which a particular vehicle 202 is assigned based on the operational parameter(s) 146. In some implementations, the route 234 indicates a plurality of stop locations. In such implementations, the operational parameter(s) 146, the output data 154, or both, specify an order of travel to the stop locations (e.g., an optimized order of travel to the stop locations), timing of stops, a start time, and end time, etc.

As yet another example, the schedule 230 may indicate a driver 236 (or operator) assigned to a particular vehicle 202, and the output data 154 may update or modify the driver 236 assigned to the particular vehicle 202 based on the operational parameter(s) 146. As another example, the schedule 230 may indicate a maintenance schedule 238 associated with a particular vehicle 202, and the output data 154 may update or modify the maintenance schedule 238 of the particular vehicle 202 based on the operational parameter(s) 146.

In some implementations, the schedule 230 indicates a conversion schedule 240 associated with a particular vehicle 202. The conversion schedule 240 indicates a timing for a full or partial conversion of the particular vehicle 202 to electric or hybrid operation. For example, the conversion schedule 240 may indicate a schedule for converting the vehicle 202B to hybrid or electric operation. The conversion schedule 204 may also indicate modifications to be performed to at least partially convert the vehicle 202B for electric or hybrid operation, such as which specific components of the vehicle 202B are to be removed and replaced. In such implementations, the output data 154 may update or modify the conversion schedule 240 of the vehicle 202B based on the operational parameter(s) 146.

As a specific example in the context of FIG. 2, the operational parameter(s) 146 may include or correspond to a cost of ownership related metric. In this example, the fleet of vehicles 202 may include one or more non-electric vehicles, such as the vehicle 202B, and at least a portion the projection data 144 and the contextual data 112 may related to the non-electric vehicle(s). To illustrate, the projection data 144 may include forecasts related to operating and maintaining the non-electric vehicle(s). In some implementations of this example, the fleet of vehicles 202 may also include one or more electric or hybrid vehicles, such as the vehicle 202A, and at least a portion the projection data 144 and the contextual data 112 may related to the electric vehicle(s). To illustrate, the projection data 144 may include forecasts related to operating and maintaining the electric vehicle(s). In this example, the optimization model(s) 138 indicate, via the operational parameter(s) 146, which non-electric vehicles should be completely or partially converted to electric or hybrid vehicles, which conversion operations would be most beneficial (e.g., among various partial conversion options and complete conversion), which routes, cargo and/or operators should be assigned to electric vehicles and which to non-electric vehicles, and so forth. As a result of the projections made by the projection model(s) 136 and the optimization operations of the optimization model(s) 138, the total cost of ownership and operation of the fleet of vehicles 202 can be reduced (relative to simple optimization using only the historical data 116).

FIG. 3 is a block diagram of another example of the system of FIG. 1. In the example, illustrated in FIG. 3, the group 101 includes a set of infrastructure devices 302. Thus, in FIG. 3, each infrastructure device 302 represents, includes, or is included within one of the devices 102 of FIG. 1. FIG. 3 also illustrates the contextual data source(s) 110, the data repository 114, and the computing device 120 of FIG. 1, each of which operates as described with reference to FIG. 1. The example illustrated in FIG. 3 provides further details regarding operation of the system 100 in the context of managing infrastructure devices 302. Examples of the infrastructure devices 302 include, without limitation: security camera systems; sensor arrays (e.g., radar or sonar arrays); buildings; bridges; towers; windmills; factories; oil exploration, extraction, or processing facilities; traffic control systems; utility systems, etc.

In the example of FIG. 3, one or more of the infrastructure devices, such as an infrastructure device(s) 302A includes power generation subsystems 304A, such as a turbine 308, a generator 310, and a controller 312A. The infrastructure device(s) 302A also includes sensor(s) 306A configured to monitor the subsystems 304A. To illustrate, the sensor(s) 306A may be configured to generate sensor data 108A, such as turbine data indicating a rate of rotation of the turbine 308, vibrations detected in the turbine 308, etc. The sensor data 108A may also include generator data indicating, for example, power out by the generator 310, a frequency of a waveform output by the generator 310, an amplitude of the waveform, a power-level of the waveform, etc.

The controller 312A of one of the infrastructure device(s) 302A is configured to control operation of the subsystems 304A of the infrastructure device 302A. For example, the controller 312A may control a rate of rotation of the turbine 308, power output by the generator 310, etc. In some implementations, the controller 312A controls the subsystems 304A responsive to one or more commands or data of the output data 154 from the computing device(s) 120. For example, the output data 154 may include a command to cause the controller 312A to modify operational characteristics of the infrastructure device 302A based on the operational parameter(s) 146.

In the example of FIG. 3, one or more of the infrastructure devices, such as an infrastructure device 302B includes subsystems 304B such as structural subsystems 320, mechanical subsystems 322, electrical subsystems 324, and a controller 312B. The infrastructure device(s) 302B also includes sensor(s) 306B that are configured to monitor the subsystems 304B. To illustrate, the sensor(s) 306B may be configured to generate sensor data 108B indicating, for example, stress, strain, or loading associated with the structural subsystems 320; oxidation or other impairment of or damage to the structural subsystem 320; a fluid level, temperature, pressure, or flow rate (such as a level, temperature, pressure, or flow rate of a lubricant) associated with one of the mechanical subsystems 322; a torque associated with one of the mechanical subsystems 322; a position associated with one of the mechanical subsystems 322; a state of charge of at least one cell of a battery associated with the electrical subsystem(s) 324; an electric current or voltage associated with the electrical subsystem(s) 324; a temperature associated with the electrical subsystem(s) 324; an alert associated with one of the subsystem 304B; and so forth.

The controller 312B of one of the infrastructure device(s) 302B is configured to control operation of the subsystems 304B of the infrastructure device 302B. For example, the controller 312B may control an actuator associated with one of the mechanical subsystems 322 or a switch or converter associated with the electrical subsystems 324. In some implementations, the controller 312B controls the subsystems 304B responsive to one or more commands or data of the output data 154 from the computing device(s) 120. For example, the output data 154 may include a command to cause the controller 312B to modify operational characteristics of the mechanical subsystems 322 or the electrical subsystems 324 based on the operational parameter(s) 146.

In some implementations, the output data 154 based on the operational parameter(s) 146 are used to store or update a schedule 330 associated with the infrastructure devices 302. For example, the schedule 330 may indicate demand 332 for particular subsystems 304B or for the output of particular subsystems 304B; modes 334 of operations of the subsystems 304; operators 336 of the subsystems 304B; maintenance 338 of the subsystems 304B; or conversion schedules 340 of the subsystems 304B.

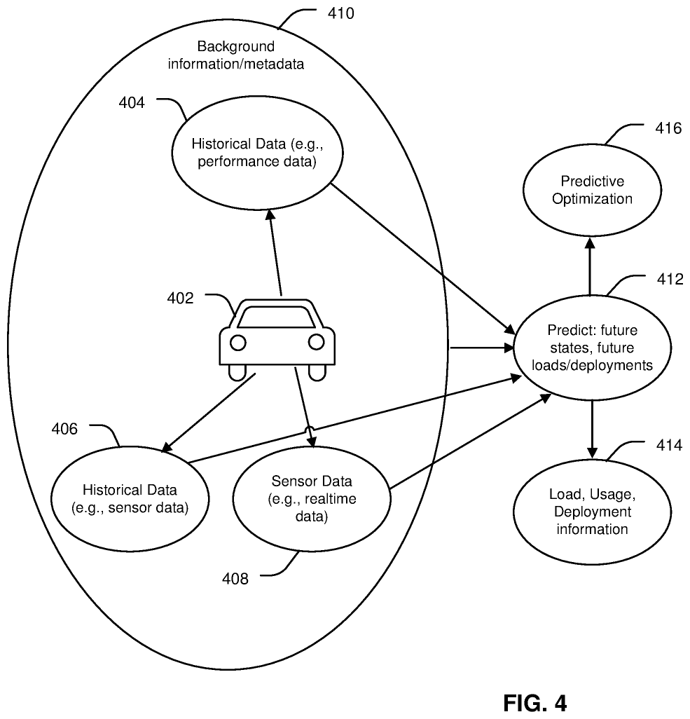

FIG. 4 is a diagram illustrating an example of operations performed by the system of FIG. 2. For example, the operations illustrated in FIG. 4 may be performed by the processor(s) 126 during execution of the instructions 132.

The operations of FIG. 4 include obtaining data. For example, the data may include background information and metadata 410. The background information and metadata 410 of FIG. 4 may include, correspond to, or be included within the contextual data 112 of FIG. 1. The data obtained in FIG. 4 also includes historical data, such as historical data 406 including sensor data from a prior period and historical data 404 including performance data. The historical data 404 and 406 of FIG. 4 may include, correspond to, or be included within the historical data 116 of FIG. 1. The data obtained in FIG. 4 may also include sensor data 408 (e.g., real-time data from sensors onboard a vehicle 402). The sensor data 408 of FIG. 4 may include, correspond to, or be included within the sensor data 108 of FIG. 1.

The operations of FIG. 4 also include predicting operations 412 to predict future states or future conditions based on the obtained data. For example, predicting operations 412 may include executing the projection model(s) 136 of FIG. 1 to forecast particular values as indicated by the projection data 144. Examples of the forecasted values include, without limitation, future states or conditions of a device (such as the vehicle 402) or a set of devices (such as a fleet of vehicles that includes the vehicle 402). Other examples of the forecasted values include, without limitation, future loads or deployments of a device (such as the vehicle 402) or a set of devices (such as a fleet of vehicles that includes the vehicle 402).

The operations of FIG. 4 also include outputting operations 414 to output data based on the predicting operations 412. For example, the outputting operations 414 may include sending the GUI 148 to the display device(s) 150 of FIG. 1, sending the output data 154 to the data repository 114, or both. Examples of the output data include, without limitation: real-time, scheduled, or forecasted load, usage, and deployment information associated with a device (such as the vehicle 402) or a set of devices (such as a fleet of vehicles that includes the vehicle 402).

The operations of FIG. 4 also include predictive optimization operations 416 to determine one or more operational parameters that are expected to improve an operational metric associated with one or more devices. For example, the predictive optimization operations 416 may include generating the operational parameter(s) 146 of FIG. 1 based on the historical data 116, the projection data 144, the sensor data 108, the contextual data 112, or a combination thereof.

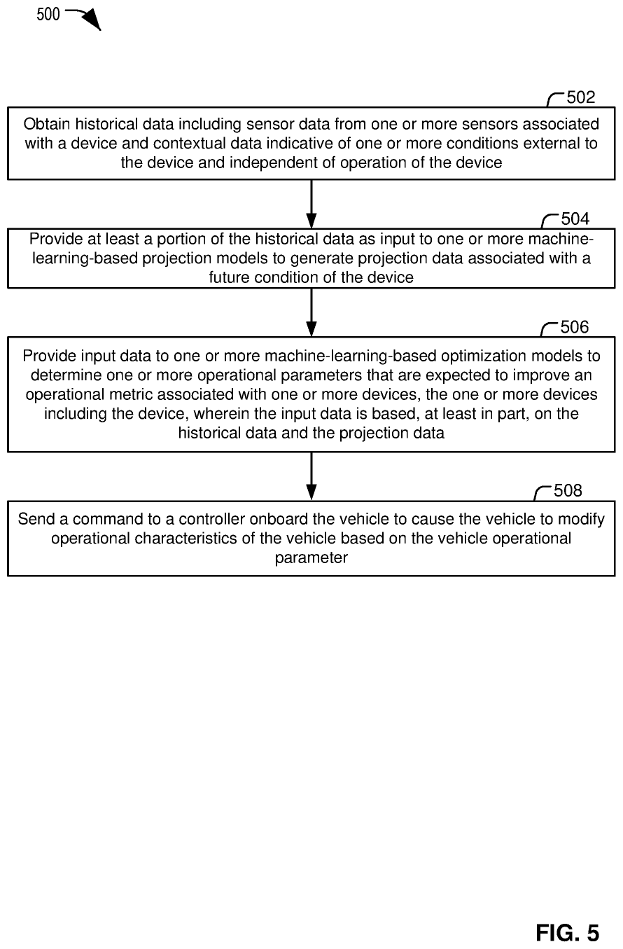

FIG. 5 is a flow chart of an example of a method 500 that may be performed by the system of any of FIGS. 1-3. For example, the method 500 may be performed by the processor(s) 126 during execution of the instructions 132 of FIG. 1.

The method 500 includes, at 502, obtaining (e.g., at one or more processors of a computing device) historical data including sensor data from one or more sensors associated with a device and contextual data indicative of one or more conditions external to the device and independent of operation of the device. For example, the computing device(s) 120 of FIG. 1 may obtain the sensor data 108, the contextual data 112, the historical data 116, or a combination thereof.

The method 500 also includes, at 504, providing at least a portion of the historical data as input to one or more machine-learning-based projection models to generate projection data associated with a future condition of the device. For example, the processor(s) 126 may provide at least a portion of the historical data 116 as input to the projection model(s) 136 to generate the projection data 144.

The method 500 further includes, at 506, providing input data to one or more machine-learning-based optimization models to determine one or more operational parameters that are expected to improve an operational metric associated with one or more devices. For example, the processor(s) 126 may generate the input data 142 based at least in part, on the historical data 116 and the projection data 144, and the processor(s) 126 may provide the input data 142 to the optimization model(s) 138 to determine the operational parameter(s) 146.

In some implementations, the method 500 also includes, at 508, sending a command to a controller onboard the device to cause the device to modify operational characteristics of the device based on the operational parameter. For example, the command may be sent as part of the output data 154 to the device(s) 102 of FIG. 1.

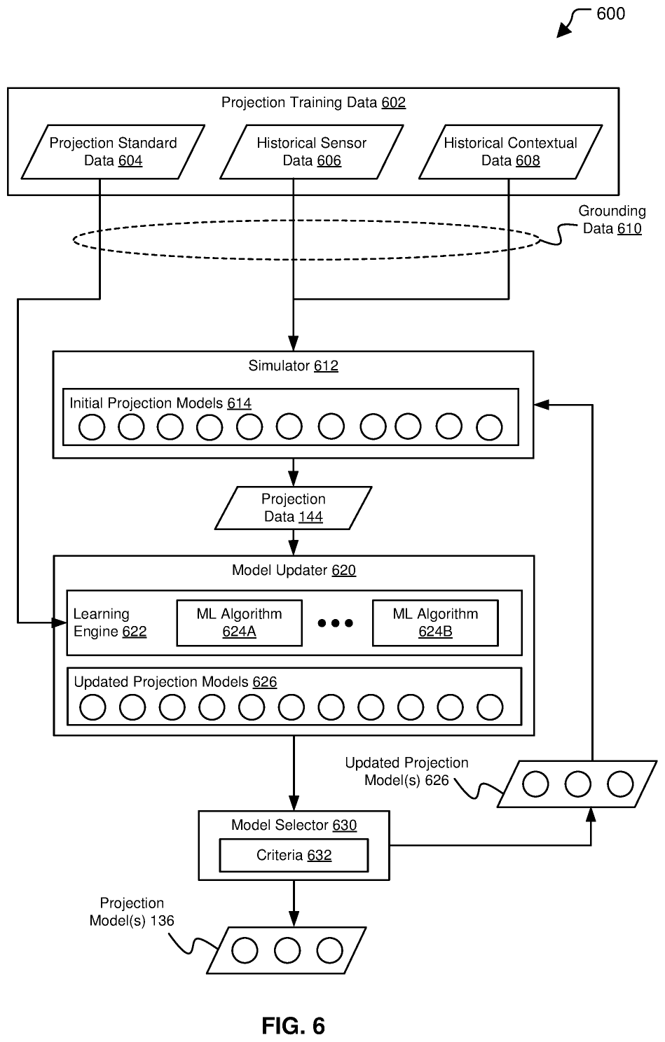

Referring to FIG. 6, a particular illustrative example of a system 600 to generate one or more machine-learning models is shown. In a particular implementation, the system 600 includes a simulator 612, a model updater 620, and a model selector 630 that are configured to cooperatively generate or update the projection model(s) 136. The system 600, or portions thereof, may be implemented using (e.g., executed by) one or more computing devices, such as laptop computers, desktop computers, mobile devices, servers, Internet of Things devices and other devices utilizing embedded processors and firmware or operating systems, etc. In particular implementations, the simulator 612, the model updater 620, and the model selector 630 are executed on two or more different devices, processors (e.g., central processor units (CPUs), graphics processing units (GPUs), other types of processors, or combinations thereof), processor cores, and/or threads (e.g., hardware threads and/or software threads). The system 600 performs an automated model building and model updating process that enables continuous or occasional updating of the projection model(s) 136 to improve accuracy of the projection model(s) 136 and to limit drift of the projection model(s) 136 over time.

The system 600 is configured to iteratively modify (e.g., train or update) a set of candidate projection models until the model selector 630 determines that one or more criteria 632 are satisfied. The operations performed by the system 600 are an example of grounded simulation learning. In grounded simulation learning, a model (or models) is used to simulate some real-world system (such as one or more of the devices 102 of FIG. 1) using historical data to generate a simulation output indicting a predicted or estimated state of the real-world system in view of the historical data. The predicted or estimated state of the real-world system in view of the historical data is compared to grounding data that indicates an actual state of the real-world system. The model used to simulate the real-world system is adjusted to reduce error between the predicted or estimated state of the real-world system and the grounding data.

In FIG. 6, projection training data 602 is used as grounding data 610. The projection training data 602 of FIG. 6 includes projection standard data 604, historical sensor data 606, and historical contextual data 608. In other examples, the projection training data 602 includes more types of data or different types of data than illustrated in FIG. 6. The historical sensor data 606 and historical contextual data 608 include historical values of the sensor data 108 and contextual data 112 of FIG. 1, and the projection standard data 604 includes actual values corresponding to projections generated based on the historical values of the sensor data 108 and contextual data 112. As one example, in FIG. 1, the sensor data 108 may include a time series of fuel flow rate values for a first time period, the contextual data 112 may include weather information during the first time period, and the projection data 144 may indicate a fuel cost prediction for a second time period that is subsequent to the first time period, where the fuel cost prediction is based, at least in part, on the time series of fuel flow rate values and the weather information. In this example, actual fuel costs for the second time period may be stored as the projection standard data 604.

The historical sensor data 606 and the historical contextual data 608 are provided to the simulator 612. The simulator 612 includes or has access to one or more initial projection models 614. The initial projection models 614 are candidates that are undergoing training or update for use by the system 100 of FIG. 1. In some implementations, two or more of the initial projection models 614 are configured to generate different projection data 144. For example, a first model of the initial projection models 614 may be configured to predict a first condition associated with a first device, and a second model of the initial projection models 614 may be configured to predict a different condition associated with the first device. In some implementations, two or more of the initial projection models 614 are configured to generate the same projection data 144 for different devices or subsystems. For example, a first model of the initial projection models 614 may be configured to predict a first condition associated with a first device, and a second model of the initial projection models 614 may be configured to predict the first condition associated with a second device. In some implementations, two or more of the initial projection models 614 are configured to cooperate to generate projection data 144. For example, output of a first model of the initial projection models 614 may be provided to second model of the initial projection models 614 to generate a prediction of a condition associated with a device.

Each of the initial projection models 614 may be based on one or more machine learning techniques. In some examples, the initial projection models 614 include a neural network (e.g., temporal convolutional network), a nonlinear regression model, a random forest, an autoencoder (e.g., time series autoencoder), or a variant or ensemble thereof. The simulator 612 provides input data derived from the projection training data 602 to each of the initial projection models 614 and provides projection data 144 generated by the initial projection models 614 to the model updater 620.

The model updater 620 determines a value of a loss function or other accuracy metric based on one or more values of the projection data 144 and one or more corresponding values of the projection standard data 604. The loss function is indicative of deviation between the predictions made by the initial projection models 614 and corresponding actual values as indicted by the projection standard data 604. A learning engine 622 of the model updater 620 uses one or more machine-learning algorithms 624A, 624B to generate updated projection models 626 that are expected to generate projection data 144 with higher accuracy (e.g., reduce the value of the loss function).

Each of the updated projection models 626 is evaluated by the model selector 630 to determine whether the updated projection models 626 satisfies one or more selection criteria 632. The selection criteria 632 may include accuracy criteria, convergence criteria, complexity criteria, iteration count criteria, other criteria, or a combination thereof. For example, an accuracy criterion may specify a minimum value of an accuracy metric or a maximum value of the loss function that a particular updated projection model 626 should satisfy. As another example, a convergence criterion may specify an iteration-to-iteration change threshold value of the loss function that a particular updated projection model 626 should satisfy. As another example, a complexity criterion may specify a complexity value (e.g., a model sparsity or processing time) that a particular updated projection model 626 should satisfy. As yet another example, an iteration count criterion may indicate a maximum allowable count of iterations of the projection model update.

Updated projection models 626 that fail to satisfy the selection criteria 632 are returned to the simulator to be used as initial projection models 614 in a subsequent iteration. Updated projection models 626 that satisfy the selection criteria 632 are output as projection models 136 which may be used by the system 100 of FIG. 1.

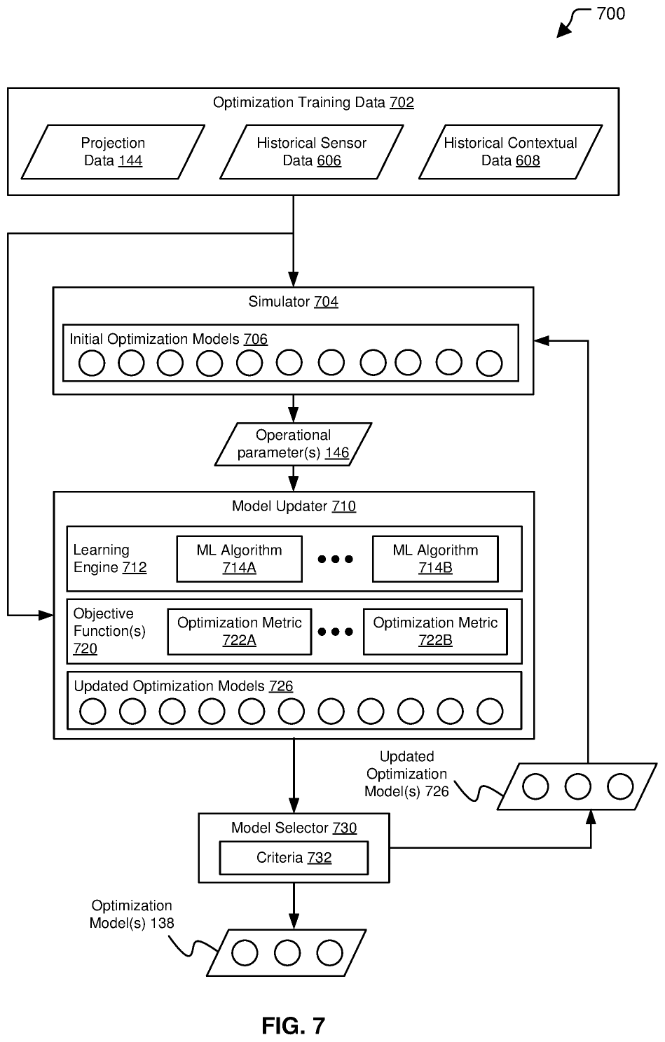

Referring to FIG. 7, a particular illustrative example of a system 700 to generate one or more machine-learning models is shown. In a particular implementation, the system 700 includes a simulator 704, a model updater 710, and a model selector 730 that are configured to cooperatively generate or update the optimization model(s) 138. The system 700, or portions thereof, may be implemented using (e.g., executed by) one or more computing devices, such as laptop computers, desktop computers, mobile devices, servers, Internet of Things devices and other devices utilizing embedded processors and firmware or operating systems, etc. In particular implementations, the simulator 704, the model updater 710, and the model selector 730 are executed on two or more different devices, processors (e.g., central processor units (CPUs), graphics processing units (GPUs), other types of processors, or combinations thereof), processor cores, and/or threads (e.g., hardware threads and/or software threads). The system 700 performs an automated model building and model updating process that enables continuous or occasional updating of the optimization model(s) 138 to improve accuracy of the optimization model(s) 138 and to limit drift of the optimization model(s) 138 over time.

The system 700 is configured to iteratively modify (e.g., train or update) a set of candidate optimization models until the model selector 730 determines that one or more criteria 732 are satisfied. The operations performed by the system 700 are another example of grounded simulation learning. In FIG. 7, the system 700 includes optimization training data 702. The optimization training data 702 includes the projection data 144, the historical sensor data 606, and the historical contextual data 608. The historical sensor data 606 and historical contextual data 608 include values used to generate the projection data 144.

The projection data 144, the historical sensor data 606, and the historical contextual data 608 are provided to the simulator 704. The simulator 704 includes or has access to one or more initial optimization models 706. The initial optimization models 706 are candidates that are undergoing training or update for use by the system 100 of FIG. 1. In some implementations, two or more of the initial optimization models 706 are configured to generate different operational parameters 146. For example, a first model of the initial optimization models 706 may be configured to generate a first operational parameter (e.g., a route) for a first device, and a second model of the initial optimization models 706 may be configured to generate a second operational parameter (e.g., a maintenance schedule) associated with the first device. In some implementations, two or more of the initial optimization models 706 are configured to generate the same operational parameters 146 for different devices or subsystems. For example, a first model of the initial optimization models 706 may be configured to generate a first operational parameter (e.g., an operator assignment) for a first device, and a second model of the initial optimization models 706 may be configured to generate the same operational parameter (e.g., an operator assignment) for a second device. In some implementations, two or more of the initial optimization models 706 are configured to cooperate to generate the operational parameter(s) 146. For example, output of a first model of the initial optimization models 706 may be provided to second model of the initial optimization models 706 to generate a particular value of the operational parameter(s) 146.

Each of the initial optimization models 706 is a machine-learning-based model, such as neural network (e.g., temporal convolutional network), a nonlinear regression model, a random forest, an autoencoder (e.g., time series autoencoder), or a variant or ensemble thereof.

The simulator 704 provides input data derived from the optimization training data 702 to each of the initial optimization models 706 and provides operational parameter(s) 146 generated by the initial optimization models 706 to the model updater 710. The model updater 710 determines values of one or more objective functions 720 based on the operational parameter(s) 146 and possibly other data. The objective function(s) 720 represent optimization targets. For example, the optimization targets may describe any measurable characteristic of a device or set of devices that is to be improved via optimization. Values of the objective function(s) 720 may be compared to optimization metrics 722A, 722B to quantify (or estimate) optimization accomplished by each of the initial optimization models 706.

A learning engine 712 of the model updater 710 uses one or more machine-learning algorithms 714A, 714B to generate updated optimization models 726 that are expected to generate operational parameter(s) 146 with improved values of the optimization metric(s) 722A, 722B. As a specific example, the machine-learning algorithms 714A, 714B may include one or more reinforcement learning algorithms. Reinforcement learning is a machine-learning paradigm that is particular well suited for training models for sequential decision-making. A simple example of sequential decision-making includes operations performed to decide when to turn on and off a thermostat to maintain temperature within certain parameters. More complex examples of sequential decision-making may include path-planning and navigation by an autonomous vehicle in response to environmental cues, such as traffic lights and other vehicles. Problems which involve sequential decision-making can be framed as Markov Decision Processes (MDPs). Inferring an optimal control policy from known MDP dynamics is referred to as solving the MDP. However, if an MDP is very large, or if it is largely unknown, solving it may be infeasible. Reinforcement learning techniques are able to simultaneously learn the properties of the MDP (either explicitly, which is referred to as “model based learning”, or implicitly, which is referred to as “model free learning”) and learn an optimal behavior policy.

Each of the updated optimization models 726 is evaluated by the model selector 730 to determine whether the updated optimization models 726 satisfies one or more selection criteria 732. The selection criteria 732 may include optimization criteria, convergence criteria, complexity criteria, iteration count criteria, other criteria, or a combination thereof. For example, an optimization criterion may specify a minimum value of an optimization metric 722A, 722B that a particular updated optimization models 726 should satisfy. As another example, a convergence criterion may specify an iteration-to-iteration change threshold value of the optimization metric 722A, 722B that a particular updated optimization models 726 should satisfy. As another example, a complexity criterion may specify a complexity value (e.g., a model sparsity or processing time) that a particular updated optimization models 726 should satisfy. As yet another example, an iteration count criterion may indicate a maximum allowable count of iterations of the projection model update.

Updated optimization models 726 that fail to satisfy the selection criteria 732 are returned to the simulator to be used as initial optimization models 706 in a subsequent iteration. Updated optimization models 726 that satisfy the selection criteria 732 are output as optimization models 138 which may be used by the system 100 of FIG. 1.

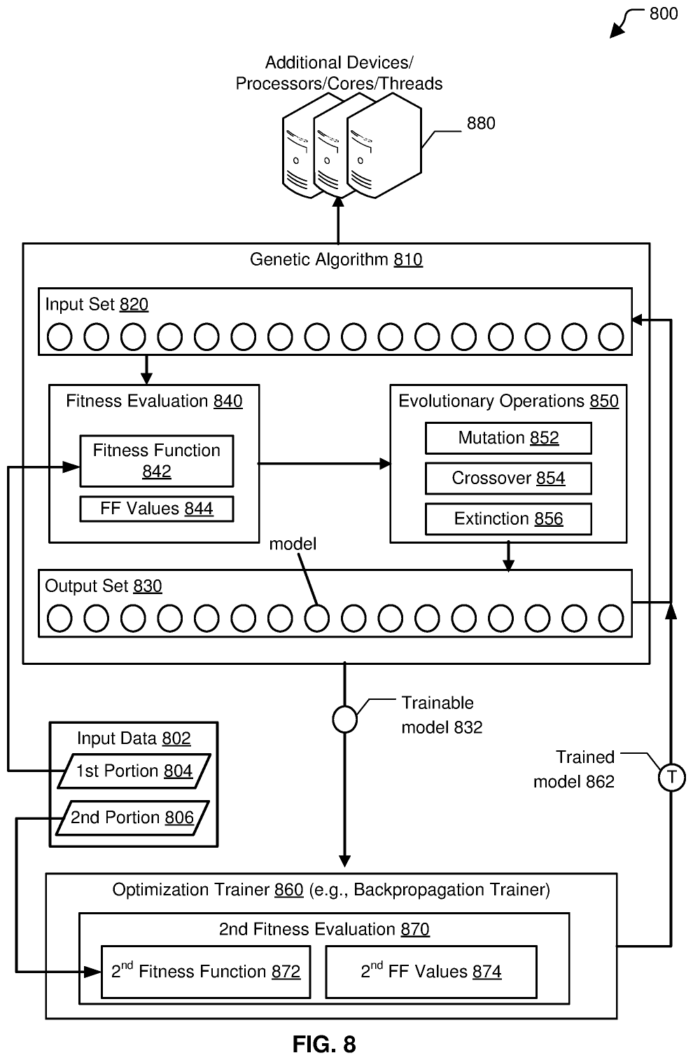

Referring to FIG. 8, another particular illustrative example of a system 800 to generate one or more machine-learning models is shown. In a particular implementation, the system 800 includes automated model builder instructions that are configured to generate and/or train the projection model(s) 136, the optimization model(s) 138, or both. The system 800, or portions thereof, may be implemented using (e.g., executed by) one or more computing devices, such as laptop computers, desktop computers, mobile devices, servers, Internet of Things devices and other devices utilizing embedded processors and firmware or operating systems, etc. In the illustrated example, the automated model builder instructions include a genetic algorithm 810 and an optimization trainer 860. The optimization trainer 860 is, for example, a backpropagation trainer, a derivative free optimizer (DFO), an extreme learning machine (ELM), etc. In particular implementations, the genetic algorithm 810 is executed on a different device, processor (e.g., central processor unit (CPU), graphics processing unit (GPU) or other type of processor), processor core, and/or thread (e.g., hardware or software thread) than the optimization trainer 860. The genetic algorithm 810 and the optimization trainer 860 are executed cooperatively to automatically generate a machine-learning model (e.g., one or more of the projection model(s) 136 and the optimization model(s) 138 and referred to herein as “models” for ease of reference) based on the input data 802 (such as the historical data 116). The system 800 performs an automated model building process that enables users, including inexperienced users, to quickly and easily build highly accurate models based on a specified data set.

During configuration of the system 800, a user specifies the input data 802. In some implementations, the user can also specify one or more characteristics of models that can be generated. In such implementations, the system 800 constrains models processed by the genetic algorithm 810 to those that have the one or more specified characteristics. For example, the specified characteristics can constrain allowed model topologies (e.g., to include no more than a specified number of input nodes or output nodes, no more than a specified number of hidden layers, no recurrent loops, etc.). Constraining the characteristics of the models can reduce the computing resources (e.g., time, memory, processor cycles, etc.) needed to converge to a final model, can reduce the computing resources needed to use the model (e.g., by simplifying the model), or both.

The user can configure aspects of the genetic algorithm 810 via input to graphical user interfaces (GUIs). For example, the user may provide input to limit a number of epochs that will be executed by the genetic algorithm 810. Alternatively, the user may specify a time limit indicating an amount of time that the genetic algorithm 810 has to execute before outputting a final output model, and the genetic algorithm 810 may determine a number of epochs that will be executed based on the specified time limit. To illustrate, an initial epoch of the genetic algorithm 810 may be timed (e.g., using a hardware or software timer at the computing device executing the genetic algorithm 810), and a total number of epochs that are to be executed within the specified time limit may be determined accordingly. As another example, the user may constrain a number of models evaluated in each epoch, for example by constraining the size of an input set 820 of models and/or an output set 830 of models.

The genetic algorithm 810 represents a recursive search process. Consequently, each iteration of the search process (also called an epoch or generation of the genetic algorithm 810) has an input set 820 of models (also referred to herein as an input population) and an output set 830 of models (also referred to herein as an output population). The input set 820 and the output set 830 may each include a plurality of models, where each model includes data representative of a machine-learning data model. For example, each model may specify a neural network or an autoencoder by at least an architecture, a series of activation functions, and connection weights. The architecture (also referred to herein as a topology) of a model includes a configuration of layers or nodes and connections therebetween. The models may also be specified to include other parameters, including but not limited to bias values/functions and aggregation functions.

For example, each model can be represented by a set of parameters and a set of hyperparameters. In this context, the hyperparameters of a model define the architecture of the model (e.g., the specific arrangement of layers or nodes and connections), and the parameters of the model refer to values that are learned or updated during optimization training of the model. For example, the parameters include or correspond to connection weights and biases.

In a particular implementation, a model is represented as a set of nodes and connections therebetween. In such implementations, the hyperparameters of the model include the data descriptive of each of the nodes, such as an activation function of each node, an aggregation function of each node, and data describing node pairs linked by corresponding connections. The activation function of a node is a step function, sine function, continuous or piecewise linear function, sigmoid function, hyperbolic tangent function, or another type of mathematical function that represents a threshold at which the node is activated. The aggregation function is a mathematical function that combines (e.g., sum, product, etc.) input signals to the node. An output of the aggregation function may be used as input to the activation function.

In another particular implementation, the model is represented on a layer-by-layer basis. For example, the hyperparameters define layers, and each layer includes layer data, such as a layer type and a node count. Examples of layer types include fully connected, long short-term memory (LSTM) layers, gated recurrent units (GRU) layers, and convolutional neural network (CNN) layers. In some implementations, all of the nodes of a particular layer use the same activation function and aggregation function. In such implementations, specifying the layer type and node count fully may describe the hyperparameters of each layer. In other implementations, the activation function and aggregation function of the nodes of a particular layer can be specified independently of the layer type of the layer. For example, in such implementations, one fully connected layer can use a sigmoid activation function and another fully connected layer (having the same layer type as the first fully connected layer) can use a tanh activation function. In such implementations, the hyperparameters of a layer include layer type, node count, activation function, and aggregation function. Further, a complete autoencoder is specified by specifying an order of layers and the hyperparameters of each layer of the autoencoder.

In a particular aspect, the genetic algorithm 810 may be configured to perform speciation. For example, the genetic algorithm 810 may be configured to cluster the models of the input set 820 into species based on “genetic distance” between the models. The genetic distance between two models may be measured or evaluated based on differences in nodes, activation functions, aggregation functions, connections, connection weights, layers, layer types, latent-space layers, encoders, decoders, etc. of the two models. In an illustrative example, the genetic algorithm 810 may be configured to serialize a model into a bit string. In this example, the genetic distance between models may be represented by the number of differing bits in the bit strings corresponding to the models. The bit strings corresponding to models may be referred to as “encodings” of the models.

After configuration, the genetic algorithm 810 may begin execution based on the input data 802. Parameters of the genetic algorithm 810 may include but are not limited to, evolutionary operation parameter(s), a maximum number of epochs the genetic algorithm 810 will be executed, a termination condition (e.g., a threshold fitness value that results in termination of the genetic algorithm 810 even if the maximum number of generations has not been reached), whether parallelization of model testing or fitness evaluation is enabled, whether to evolve a feedforward or recurrent neural network, etc. The evolutionary operation parameters specify or affect the likelihood of various evolutionary operations 850 occurring with respect to a candidate neural network, the extent or effect of each evolutionary operations 850 (e.g., how many bits, bytes, fields, characteristics, etc. change due to a mutation operation 852), and/or the types of the evolutionary operations 850 used (e.g., whether a mutation operation 852 changes a node characteristic, a link characteristic, etc.). In some examples, the genetic algorithm 810 uses a single set of evolutionary operation parameters for all of the models. In alternative examples, the genetic algorithm 810 maintains multiple sets of evolutionary operation parameters, such as for individual or groups of models or species.

For an initial epoch of the genetic algorithm 810, the architectures of the models in the input set 820 may be randomly or pseudo-randomly generated within constraints specified by the configuration settings or by one or more architectural parameters. Accordingly, the input set 820 may include models with multiple distinct architectures. For example, a first model of the initial epoch may have a first architecture, including a first number of input nodes associated with a first set of data parameters, a first number of hidden layers including a first number and arrangement of hidden nodes, one or more output nodes, and a first set of interconnections between the nodes. In this example, a second model of the initial epoch may have a second architecture, including a second number of input nodes associated with a second set of data parameters, a second number of hidden layers including a second number and arrangement of hidden nodes, one or more output nodes, and a second set of interconnections between the nodes. The first model and the second model may or may not have the same number of input nodes and/or output nodes. Further, one or more layers of the first model can be of a different layer type that one or more layers of the second model. For example, the first model can be a feedforward model, with no recurrent layers; whereas, the second model can include one or more recurrent layers.

The genetic algorithm 810 may automatically assign an activation function, an aggregation function, a bias, connection weights, etc. to each model of the input set 820 for the initial epoch. In some aspects, the connection weights are initially assigned randomly or pseudo-randomly. In some implementations, a single activation function is used for each node of a particular model. For example, a sigmoid function may be used as the activation function of each node of the particular model. The single activation function may be selected based on configuration data. For example, the configuration data may indicate that a hyperbolic tangent activation function is to be used or that a sigmoid activation function is to be used. Alternatively, the activation function may be randomly or pseudo-randomly selected from a set of allowed activation functions, and different nodes or layers of a model may have different types of activation functions. Aggregation functions may similarly be randomly or pseudo-randomly assigned for the models in the input set 820 of the initial epoch. Thus, the models of the input set 820 of the initial epoch may have different architectures (which may include different input nodes corresponding to different input data fields if the data set includes many data fields) and different connection weights. Further, the models of the input set 820 of the initial epoch may include nodes having different activation functions, aggregation functions, and/or bias values/functions.

During execution, the genetic algorithm 810 performs fitness evaluation 840 and evolutionary operations 850 on the input set 820. In this context, fitness evaluation 840 includes evaluating each model of the input set 820 using a fitness function 842 to determine a fitness function value 844 (“FF values” in FIG. 8) for each model of the input set 820. The fitness function values 844 are used to select one or more models of the input set 820 to modify using one or more of the evolutionary operations 850. In FIG. 8, the evolutionary operations 850 include mutation operations 852, crossover operations 854, and extinction operations 856, each of which is described further below.

During the fitness evaluation 840, each model of the input set 820 is tested based on the input data 802 to determine a corresponding fitness function value 844. For example, a first portion 804 of the input data 802 may be provided as input data to each model, which processes the input data (according to the network topology, connection weights, activation function, etc., of the respective model) to generate output data. The output data of each model is evaluated using the fitness function 842 and the first portion 804 of the input data 802 to determine how well the model modeled the input data 802. In some examples, fitness of a model is based on reliability of the model, performance of the model, complexity (or sparsity) of the model, size of the latent space, or a combination thereof.

In a particular aspect, fitness evaluation 840 of the models of the input set 820 is performed in parallel. To illustrate, the system 800 may include devices, processors, cores, and/or threads 880 in addition to those that execute the genetic algorithm 810 and the optimization trainer 860. These additional devices, processors, cores, and/or threads 880 can perform the fitness evaluation 840 of the models of the input set 820 in parallel based on a first portion 804 of the input data 802 and may provide the resulting fitness function values 844 to the genetic algorithm 810.

The mutation operation 852 and the crossover operation 854 are highly stochastic under certain constraints and a defined set of probabilities optimized for model building, which produces reproduction operations that can be used to generate the output set 830, or at least a portion thereof, from the input set 820. In a particular implementation, the genetic algorithm 810 utilizes intra-species reproduction (as opposed to inter-species reproduction) in generating the output set 830. In other implementations, inter-species reproduction may be used in addition to or instead of intra-species reproduction to generate the output set 830. Generally, the mutation operation 852 and the crossover operation 854 are selectively performed on models that are more fit (e.g., have higher fitness function values 844, fitness function values 844 that have changed significantly between two or more epochs, or both).

The extinction operation 856 uses a stagnation criterion to determine when a species should be omitted from a population used as the input set 820 for a subsequent epoch of the genetic algorithm 810. Generally, the extinction operation 856 is selectively performed on models that are satisfy a stagnation criteria, such as models that have low fitness function values 844, fitness function values 844 that have changed little over several epochs, or both.

In accordance with the present disclosure, cooperative execution of the genetic algorithm 810 and the optimization trainer 860 is used to arrive at a solution faster than would occur by using a genetic algorithm 810 alone or an optimization trainer 860 alone. Additionally, in some implementations, the genetic algorithm 810 and the optimization trainer 860 evaluate fitness using different data sets, with different measures of fitness, or both, which can improve fidelity of operation of the final model. To facilitate cooperative execution, a model (referred to herein as a trainable model 832 in FIG. 8) is occasionally sent from the genetic algorithm 810 to the optimization trainer 860 for training. In a particular implementation, the trainable model 832 is based on crossing over and/or mutating the fittest models (based on the fitness evaluation 840) of the input set 820. In such implementations, the trainable model 832 is not merely a selected model of the input set 820; rather, the trainable model 832 represents a potential advancement with respect to the fittest models of the input set 820.

The optimization trainer 860 uses a second portion 806 of the input data 802 to train the connection weights and biases of the trainable model 832, thereby generating a trained model 862. The optimization trainer 860 does not modify the architecture of the trainable model 832.

During optimization, the optimization trainer 860 provides a second portion 806 of the input data 802 to the trainable model 832 to generate output data. The optimization trainer 860 performs a second fitness evaluation 870 by comparing the data input to the trainable model 832 to the output data from the trainable model 832 to determine a second fitness function value 874 based on a second fitness function 872. The second fitness function 872 is the same as the first fitness function 842 in some implementations and is different from the first fitness function 842 in other implementations. In some implementations, the optimization trainer 860 uses a reinforcement learning training process to train the trainable model 832. In some implementations, the optimization trainer 860 uses simulation-based training. For example, the optimization trainer 860 may include the simulator 612, the model updater 620 and the model selector 630 of FIG. 6. As another example, the optimization trainer 860 may include the simulator 704, the model updater 710 and the model selector 730 of FIG. 7. In some implementations, the optimization trainer 860 or portions thereof is executed on a different device, processor, core, and/or thread than the genetic algorithm 810. In such implementations, the genetic algorithm 810 can continue executing additional epoch(s) while the connection weights of the trainable model 832 are being trained by the optimization trainer 860. When training is complete, the trained model 862 is input back into (a subsequent epoch of) the genetic algorithm 810, so that the positively reinforced “genetic traits” of the trained model 862 are available to be inherited by other models in the genetic algorithm 810.

In implementations in which the genetic algorithm 810 employs speciation, a species ID of each of the models may be set to a value corresponding to the species that the model has been clustered into. A species fitness may be determined for each of the species. The species fitness of a species may be a function of the fitness of one or more of the individual models in the species. As a simple illustrative example, the species fitness of a species may be the average of the fitness of the individual models in the species. As another example, the species fitness of a species may be equal to the fitness of the fittest or least fit individual model in the species. In alternative examples, other mathematical functions may be used to determine species fitness. The genetic algorithm 810 may maintain a data structure that tracks the fitness of each species across multiple epochs. Based on the species fitness, the genetic algorithm 810 may identify the “fittest” species, which may also be referred to as “elite species.” Different numbers of elite species may be identified in different embodiments.

In a particular aspect, the genetic algorithm 810 uses species fitness to determine if a species has become stagnant and is therefore to become extinct. As an illustrative non-limiting example, the stagnation criterion of the extinction operation 856 may indicate that a species has become stagnant if the fitness of that species remains within a particular range (e.g., +/−5%) for a particular number (e.g., 5) of epochs. If a species satisfies a stagnation criterion, the species and all underlying models may be removed from subsequent epochs of the genetic algorithm 810.

In some implementations, the fittest models of each “elite species” may be identified. The fittest models overall may also be identified. An “overall elite” need not be an “elite member,” e.g., may come from a non-elite species. Different numbers of “elite members” per species and “overall elites” may be identified in different embodiments.

The output set 830 of the epoch is generated based on the input set 820 and the evolutionary operation 850. In the illustrated example, the output set 830 includes the same number of models as the input set 820. In some implementations, the output set 830 includes each of the “overall elite” models and each of the “elite member” models. Propagating the “overall elite” and “elite member” models to the next epoch may preserve the “genetic traits” resulted in caused such models being assigned high fitness values.

The rest of the output set 830 may be filled out by random reproduction using the crossover operation 854 and/or the mutation operation 852. After the output set 830 is generated, the output set 830 may be provided as the input set 820 for the next epoch of the genetic algorithm 810.

After one or more epochs of the genetic algorithm 810 and one or more rounds of optimization by the optimization trainer 860, the system 800 selects a particular model or a set of model as the final model (e.g., one of the machine-learning models 136, 138). For example, the final model may be selected based on the fitness function values 844, 874. For example, a model or set of models having the highest fitness function value 844 or 874 may be selected as the final model. When multiple models are selected (e.g., an entire species is selected), an ensembler can be generated (e.g., based on heuristic rules or using the genetic algorithm 810) to aggregate the multiple models. In some implementations, the final model can be provided to the optimization trainer 860 for one or more rounds of optimization after the final model is selected. Subsequently, the final model can be output for use with respect to other data (e.g., real-time data).

In some implementations, one or more final models generated by the genetic algorithm 810 and optimization trainer 860 of FIG. 8 can be uses as initial projection model(s) 614 in FIG. 6 or as initial optimization models 706 in FIG. 7.

It will be appreciated that one or more aspects of the present disclosure can be used in systems and methods to solve various types of problems. As an illustrative non-limiting example, consider a problem in which the solution includes a sequence of actions or steps. One such problem is deciding when the convert an existing diesel-powered vehicle into an electric vehicle. In the case of diesel-to-EV conversion, a combination of historical data and projection and/or optimization models can be used to predict the consequences of converting a particular vehicle from diesel to electric at a particular point in time, and by extension predict an “optimum,” or at least advisable, period to perform such conversion, and thus a recommended fleet-wide order in which to transition vehicles. As another example, once a vehicle has been converted to electric, one or more aspects of the vehicle (charging, load scheduling, maintenance, threshold adjustments for hybrid vs. fully electric, etc.) may be controlled using the techniques of the present disclosure. To illustrate, one or more machine learning models may be trained based on historical data and/or empirically measured data to provide output suggesting how to schedule cargo loads, when to charge an electric vehicle battery, how to perform fleet-wide and vehicle-specific route optimizations, etc.

The systems and methods illustrated herein may be described in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as, but not limited to, C, C++, C#, Java, JavaScript, VBScript, Macromedia Cold Fusion, COBOL, Microsoft Active Server Pages, assembly, PERL, PHP, AWK, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of techniques for data transmission, signaling, data processing, network control, and the like.

The systems and methods of the present disclosure may take the form of or include a computer program product on a computer-readable storage medium or device having computer-readable program code (e.g., instructions) embodied or stored in the storage medium or device. Any suitable computer-readable storage medium or device may be utilized, including hard disks, CD-ROM, optical storage devices, magnetic storage devices, and/or other storage media. As used herein, a “computer-readable storage medium” or “computer-readable storage device” is not a signal.

Systems and methods may be described herein with reference to block diagrams and flowchart illustrations of methods, apparatuses (e.g., systems), and computer media according to various aspects. It will be understood that each functional block of a block diagrams and flowchart illustration, and combinations of functional blocks in block diagrams and flowchart illustrations, respectively, can be implemented by computer program instructions.

Computer program instructions may be loaded onto a computer or other programmable data processing apparatus to produce a machine, such that the instructions that execute on the computer or other programmable data processing apparatus create means for implementing the actions specified in the flowchart block or blocks. These computer program instructions may also be stored in a computer-readable memory or device that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

Although the disclosure may include a method, it is contemplated that it may be embodied as computer program instructions on a tangible computer-readable medium, such as a magnetic or optical memory or a magnetic or optical disk/disc. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

Changes and modifications may be made to the disclosed embodiments without departing from the scope of the present disclosure. These and other changes or modifications are intended to be included within the scope of the present disclosure, as expressed in the following claims.

What is claimed is:

1. A method comprising:
obtaining, at one or more processors of a computing device, historical data including sensor data from one or more sensors associated with a device and contextual data indicative of one or more conditions external to the device and independent of operation of the device;
providing, by the one or more processors, at least a portion of the historical data as input to one or more machine-learning-based projection models to generate projection data associated with a future condition of the device; and
providing, by the one or more processors, input data to one or more machine-learning-based optimization models to determine one or more operational parameters that are expected to improve an operational metric associated with one or more devices, the one or more devices including the device, wherein the input data is based, at least in part, on the historical data and the projection data.

2. The method of claim 1, wherein the one or more operational parameters assign at least one of an operational schedule to the device, the operational schedule indicating a start time, a stop time, a maintenance schedule, a charge time, a route, or a combination thereof.

3. The method of claim 1, wherein the device includes, corresponds to, or is included within a generator, an engine, a motor, a turbine, or a combination there.

4. The method of claim 1, wherein the one or more devices include, correspond to, or are included within a sensor array, one or more unmanned vehicles, one or more security cameras, one or more infrastructure devices, or a combination thereof.

5. The method of claim 1, wherein the device includes, corresponds to, or is included within a vehicle and the one or more operational parameters include a vehicle operational parameter.

6. The method of claim 5, wherein the vehicle includes an internal combustion engine and the vehicle operational parameter indicates a timing for a full or partial conversion of the vehicle to electric or hybrid operation.

7. The method of claim 5, wherein the vehicle includes an internal combustion engine and the vehicle operational parameter indicates modifications to be performed to at least partially convert the vehicle for electric or hybrid operation.

8. The method of claim 5, wherein the vehicle operational parameter assigns the vehicle to a particular route.

9. The method of claim 5, wherein the vehicle is assigned to a particular route including a plurality of stop locations and the vehicle operational parameter specifies an order of travel to the stop locations.

10. The method of claim 5, wherein the vehicle operational parameter assigns particular cargo to the vehicle.

11. The method of claim 10, wherein the contextual data includes a demand projection and the particular cargo is selected based in part on the demand projection.

12. The method of claim 1, wherein the one or more operational parameters assign a particular device operator to the device.

13. The method of claim 1, further comprising obtaining projection data associated with one or more additional devices of a group of devices, wherein the input data to one or more machine-learning-based optimization models is further based, at least in part, on the projection data associated with the one or more additional devices, and wherein the one or more machine-learning-based optimization models determine groupwide operational parameters, the groupwide operational parameters including the operational parameter and one or more additional operational parameters associated with the one or more additional devices of the group.

14. The method of claim 1, wherein the sensor data indicates a state of charge of at least one cell of a battery of the device, an electric current load associated with the devices, a cell voltage of at least one cell of the battery, a cell temperature of at least one cell of the battery, a fluid pressure of a fluid of the device, a speed of the device, an acceleration of the device, a braking metric associated with the device, a weight of the device, a weight of cargo of the device, a center of gravity of the device, a cargo identifier, a cargo type of the device, a rotation rate associated with the device, an alert associated with the device, a fluid flow rate associated with the device, torque output of a component of the device, chemical reaction metric associated with the device, a frequency of a waveform associated with the device, an amplitude of the waveform, an encoding scheme of the waveform, an indication of a type of the waveform, a power-level of the waveform.

15. The method of claim 1, wherein the contextual data indicates route topography, road quality, weather, a route type, availability of other vehicles, fuel cost, historical demand information, or a combination thereof.

16. The method of claim 1, wherein the projection data indicates a future configuration requirement associated with the device, a future demand associated with the device, future sensor data value associated with the one or more sensors, a cost prediction, or a combination thereof.

17. The method of claim 1, wherein the one or more machine-learning-based projection models are further configured to generate contextual projection data indicative of a forecast the one or more conditions external to the device.

18. The method of claim 1, wherein the one or more machine-learning-based projection models include one or more neural networks, one or more nonlinear regression models, one or more random forests, one or more reinforcement learning models, or a combination thereof.

19. The method of claim 1, wherein the one or more operational parameters includes one or more of a calibration setting of a subsystem of the device, a maintenance schedule of the device, a control profile of the device, a fuel consumption parameter, a route assignment, a route schedule, or a combination thereof.

20. The method of claim 1, wherein the one or more machine-learning-based optimization models include one or more neural networks, one or more nonlinear regression models, one or more random forests, one or more reinforcement learning models, or a combination thereof.

21. The method of claim 1, further comprising sending a command to a controller onboard the device to cause the device to modify operational characteristics of the device based on the operational parameter.

22. A device comprising:
one or more memory devices storing historical data including sensor data from one or more sensors associated with a device and contextual data indicative of one or more conditions external to the device and independent of operation of the device; and
one or more processors configured to:
provide at least a portion of the historical data as input to one or more machine-learning-based projection models to generate projection data associated with a future condition of the device; and
provide input data to one or more machine-learning-based optimization models to determine one or more operational parameters that are expected to improve an operational metric associated with one or more devices, the one or more devices including the device, wherein the input data is based, at least in part, on the historical data and the projection data.

23. A non-transitory computer-readable medium storing instructions that are executable by one or more processors to cause the one or more processors to perform operations comprising:
obtaining historical data including sensor data from one or more sensors associated with a device and contextual data indicative of one or more conditions external to the device and independent of operation of the device;
providing at least a portion of the historical data as input to one or more machine-learning-based projection models to generate projection data associated with a future condition of the device; and
providing input data to one or more machine-learning-based optimization models to determine one or more operational parameters that are expected to improve an operational metric associated with one or more devices, the one or more devices including the device, wherein the input data is based, at least in part, on the historical data and the projection data.
